(19) United States
(12) Patent Application Publication
(10) Pub. No.: US 2002/0068263 A1
(43) Pub. Date: Jun. 6, 2002

(54) Method and apparatus for facilitating a computer-based peer review process

(76) Inventors: Paul B. Mishkin, Sunnyvale, CA (US); Jinglin Gu, Sunnyvale, CA (US); Tara L. McLaughlin, San Mateo, CA (US); Joseph H. Kent III, Burlingame, CA (US)

Correspondence Address: PARK, VAUGHAN & FLEMING LLP, 508 SECOND STREET, SUITE 201, DAVIS, CA, 95616, US

(21) Appl. No.: 09/729,727

(22) Filed: Dec. 4, 2000

(51) Int. Cl. G09B 3/00; G09B 7/00

(52) U.S. Cl. 434/322

(57) ABSTRACT

One embodiment of the present invention provides a system that facilitates a peer review process for a computer-based activity, such as a computer-based quiz. Upon receiving a computer-based activity to be evaluated, the system makes the computer-based activity available on a computer system coupled to a network, so that the computer-based activity can be accessed by a plurality of evaluators operating from remote computer systems across the network. Upon receiving evaluations from the plurality of evaluators, the system tabulates the evaluations to produce an evaluation result. In one embodiment of the present invention, the computer-based activity includes one of: a computer-based quiz; a computer-based examination; and a computer-based game. In one embodiment of the present invention, if the evaluation result exceeds a threshold, the computer-based activity is placed in a public directory on the computer system, so that the computer-based activity becomes available to activity users from remote computer systems across the network.

### BACKGROUND

1. Field of the Invention

The present invention relates to performing reviews on computer-based activities, such as games and quizzes. More specifically, the present invention relates to a method and an apparatus for facilitating a computer-based peer review process for computer-based activities.

2. Related Art

The recent proliferation of computer technology makes it possible to automate many tasks involving the manipulation of information. In particular, computers can automate the process of administering educational quizzes and examinations by making a quiz or an examination available on line. This provides a number of advantages.

Making a quiz available on line reduces paperwork by eliminating the time-consuming process of copying the quiz onto sheets of paper to distribute to students. Furthermore, computer technology can automate the process of preparing and formatting the quiz before it is distributed.

Making a quiz available on line can automate the process of scoring student responses to the quiz. Additionally, after a number of quizzes have been scored, computers can automate the process of gathering quiz scores and determining grades for the quiz as well as recording the grades.

Making a quiz available on line allows students to more easily take the quiz. If a quiz is made available across a computer network, such as the Internet, it is possible for students to take the quiz from different geographical locations. Making a quiz available on line also allows students to take the quiz at different times.

Furthermore, making a quiz available on line facilitates sharing of the quiz between educators. At least one existing web site allows educators to share quizzes, so that when an educator creates a quiz, the quiz can be used by other educators. As a web site of this type increases in size, the process of reviewing activities to be included on the web site becomes increasingly more difficult. It may be necessary to review thousands of quizzes in hundreds of different categories. Hence, a large amount of review time may be required to review all of the quizzes, and the reviewers may need to have specialized knowledge in hundreds of disparate subject areas.

What is needed is a method and an apparatus that facilitates efficiently reviewing computer-based activities, such as computer-based quizzes.

### SUMMARY

One embodiment of the present invention provides a system that facilitates a peer review process for a computer-based activity, such as a computer-based quiz. Upon receiving a computer-based activity to be evaluated, the system makes the computer-based activity available on a computer system coupled to a network, so that the computer-based activity can be accessed by a plurality of evaluators operating from remote computer systems across the network. Upon receiving evaluations from the plurality of evaluators, the system tabulates the evaluations to produce an evaluation result.

In one embodiment of the present invention, the computer-based activity includes one of: a computer-based quiz; a computer-based examination; and a computer-based game.

In one embodiment of the present invention, receiving the computer-based activity involves receiving a nomination for the computer-based activity from a creator of the computer-based activity.

In one embodiment of the present invention, making the computer-based activity available for evaluation involves making the computer-based activity available on a web site that is accessible by the plurality of evaluators.

In one embodiment of the present invention, if the evaluation result exceeds a threshold, the computer-based activity is placed in a public directory on the computer system, so that the computer-based activity becomes available to activity users from remote computer systems across the network.

In one embodiment of the present invention, the system makes the evaluation result available to activity users who can access the computer-based activity.

In one embodiment of the present invention, the system automatically screens the computer-based activity for offensive language before making the computer-based activity available for evaluation.

In one embodiment of the present invention, the system waits until a minimum number of evaluations are received for the computer-based activity before tabulating the evaluations.

In one embodiment of the present invention, the computer-based activity is a computer-based quiz, and the evaluations include scores for, spelling and grammar, accuracy, topic coverage, and usefulness of the computer-based quiz.

In one embodiment of the present invention, making the computer-based activity available for evaluation involves making the computer-based activity accessible under an activity category that is specified by a creator of the computer-based activity.

In one embodiment of the present invention, the evaluations include textual comments from the plurality of evaluators.

### BRIEF DESCRIPTION OF THE FIGURES

FIG. 1 illustrates a number of computer systems coupled together by a network in accordance with an embodiment of the present invention.

FIG. 2 is a flow chart illustrating the process of facilitating peer review of an activity in accordance with an embodiment of the present invention.

FIG. 3 illustrates the structure of a portion of a web site for facilitating peer review of activities in accordance with an embodiment of the present invention.

FIG. 4 illustrates a nominated activities page in accordance with an embodiment of the present invention.

FIG. 5 illustrates a nominated activities category page in accordance with an embodiment of the present invention.

FIG. 6 illustrates an activity page for a nominated activity in accordance with an embodiment of the present invention.

FIG. 7 illustrates a page that presents review results for an activity in accordance with an embodiment of the present invention.

FIG. 8 illustrates an activity review page in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

### Computer Systems

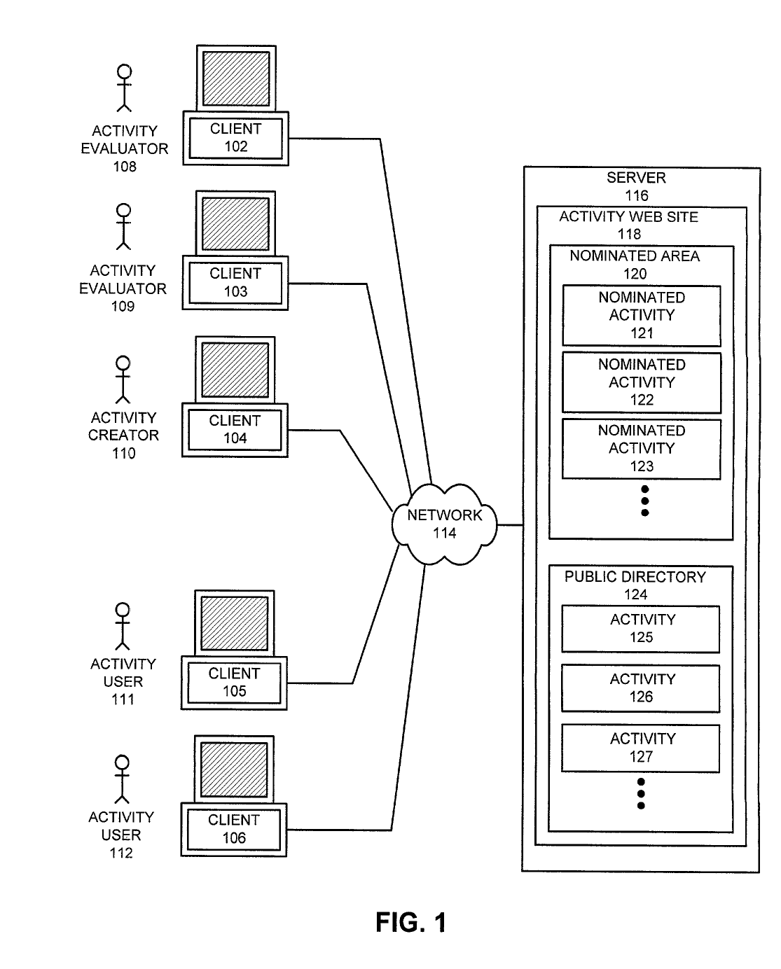

FIG. 1 illustrates a number of computer systems 102-106 and 116 coupled together by a network 114 in accordance with an embodiment of the present invention. Network 114 can generally include any type of wire or wireless communication channel capable of coupling together computing nodes. This includes, but is not limited to, a local area network, a wide area network, or a combination of networks. In one embodiment of the present invention, network 114 includes the Internet.

Computer system 102-106 and 116 can generally include any type of computer system, including, but not limited to, a computer system based on a microprocessor, a mainframe computer, a digital signal processor, a portable computing device, a personal organizer, a device controller, and a computational engine within an appliance.

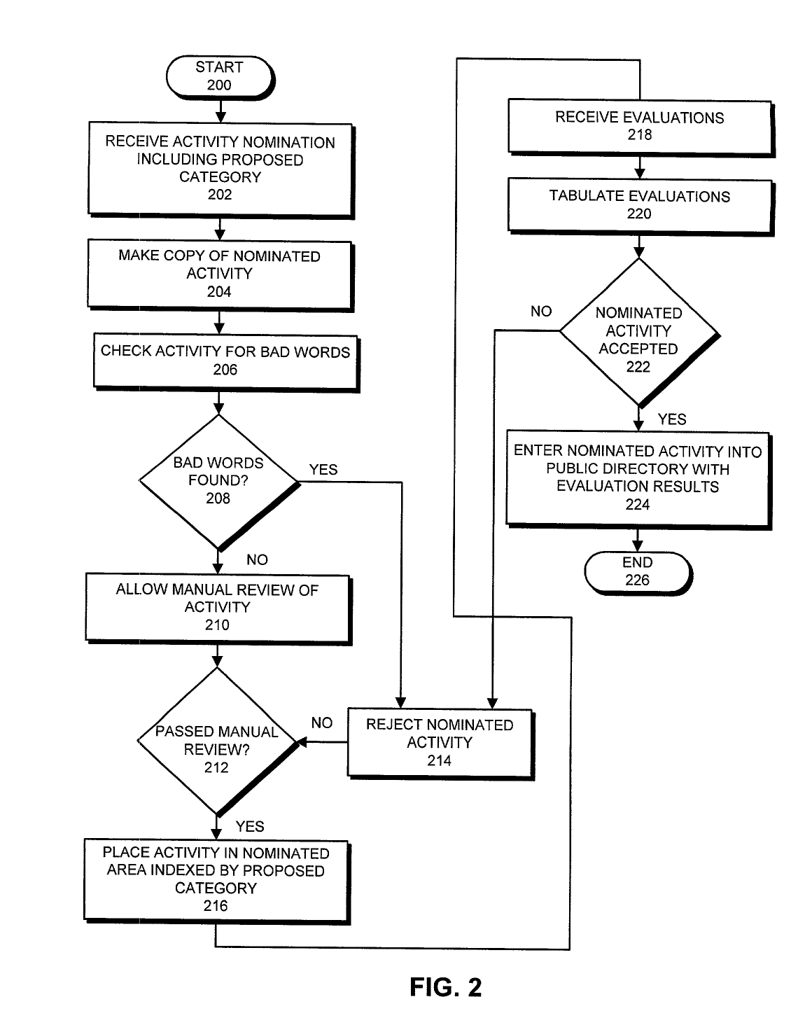

More specifically, client computer systems 102-106 can generally include any node on network 114 including computational capability and including a mechanism for communicating across network 114. Clients 102 and 103 are operated by activity evaluators 108 and 109, respectively, who evaluate nominated activities as is described in more detail below with reference to FIGS. 2-8. Client 104 is operated by activity creator 110, who creates an activity and nominates the activity to be made publicly available on activity web site 118. Clients 105 and 106 are operated by activity users 111 and 112, respectively. Activity users 111-112 make use of activities contained within public directory 124. Note that in general a single person can be an activity creator, an activity evaluator and an activity user.

Server 116 can generally include any computational node including a mechanism for servicing requests from a client for computational and/or data storage resources. Server 116 makes activity web site 118 available to users 108-112 across network 114. Activity web site 118 contains inter-linked pages of textual and graphical information that can be navigated through by users 108-112 who operate web browsers located on clients 102-106.

Activity web site 118 includes a nominated area 120 containing nominated activities 121-123 that can be reviewed by activity evaluators 108-109. Activity web site 118 also includes public directory 124, which contains reviewed activities 125-127 for use by activity users 111-112. Note that an activity can refer to any type of computer program that can be made available on a computer system, including a computer-based quiz, a computer-based examination or a computer-based game.

Furthermore, note that although the present invention is described in terms of an activity web site 118 on a server 116, the present invention can generally be implemented on any computer system. Hence, the present invention is not limited to systems designed around web sites or client-server systems.

During operation, the system illustrated in FIG. 1 operates generally as follows. Activity creator 110 creates an activity and nominates it to appear on activity web site 118. Next, the activity is made available within nominated area 120 within activity web site 118. This enables activity evaluators 108-109 to test the activity, and to return evaluations for the activity to server 116. If the activity receives favorable evaluations, it is moved to public directory 124 within activity web site 118. This enables activity users 111-112 to use the activity.

### Peer Review Process

FIG. 2 is a flow chart illustrating the process of facilitating peer review of an activity in accordance with an embodiment of the present invention. The system first receives an activity nomination from activity creator 110 (step 202). This nomination includes a reference to the activity as well as a proposed category for the activity. Note that a new activity may not fit into an existing category. Hence, a new category may have to be created for the new activity.

Next, the system makes a copy of the nominated activity (step 204). This is done to ensure that the copy of the activity will not change over time, even if the activity creator 110 modifies the activity.

The system then automatically checks the activity for offensive language (step 206). If no offensive language is found, the system optionally allows for manual review of the activity (step 210). If the activity passes manual review, the activity is placed in nominated area 120 within activity web site 118, and is indexed by the proposed category (step 216). This enables activity evaluators 108-109 to evaluate the activity.

Next, the system receives evaluations from activity evaluators 108-109 (step 218), and tabulates the evaluations to produce an evaluation result for the activity (step 220). This may involve waiting until a minimum number of evaluations are received before tabulating the evaluations. In one embodiment of the present invention, if an activity evaluator evaluates the same activity more than once, the system only considers the most recent evaluations in forming the evaluation result. This prevents a single activity evaluator from receiving more weight than other evaluators.

Based on the evaluation result, the system determines whether the activity is acceptable to go into public directory 124 (step 222). In one embodiment of the present invention, the system facilitates a manual process to determine if the activity is acceptable. This is accomplished by displaying activities to a person who is responsible for determining whether the activity is acceptable. The activities can be displayed sorted by number of reviews and/or average score. This allows the person to make proper category assignments.

In another embodiment of the present invention, the system uses an automated process to determine whether an activity is acceptable. This can be accomplished by first determining if an activity has a minimum number of reviews. If so, the activity is automatically rejected if the average score for the activity is less than or equal to a minimum value, Y, and automatically accepted if the average score is greater than or equal to a threshold value Z. The system can also provide a manual selection process for the borderline activities with average scores between Y and Z.

If the activity is acceptable, the system enters the activity in public directory 124 within activity web site 118 in FIG. 1 (step 224). The system can also make the evaluation results available in public directory 124 in order to allow activity users 111-112 to see the evaluation results.

Note that if offensive language found in the activity (in step 208), if the activity does not pass review (in step 212), or if the nominated activity is not acceptable based upon the tabulated evaluation results (in step 222), the system rejects the nominated activity (step 214).

### Web Site for Facilitating Peer Review Process

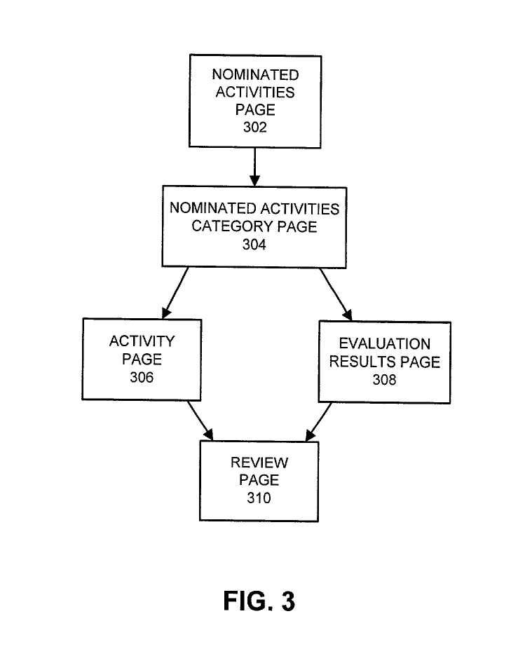

FIG. 3 illustrates the structure of a portion of activity web site 118 for facilitating peer review of activities in accordance with an embodiment of the present invention. This portion of activity web site 118 includes nominated activities page 302, nominated activities category page 304, activity page 306, evaluation results page 308 and activity review page 310.

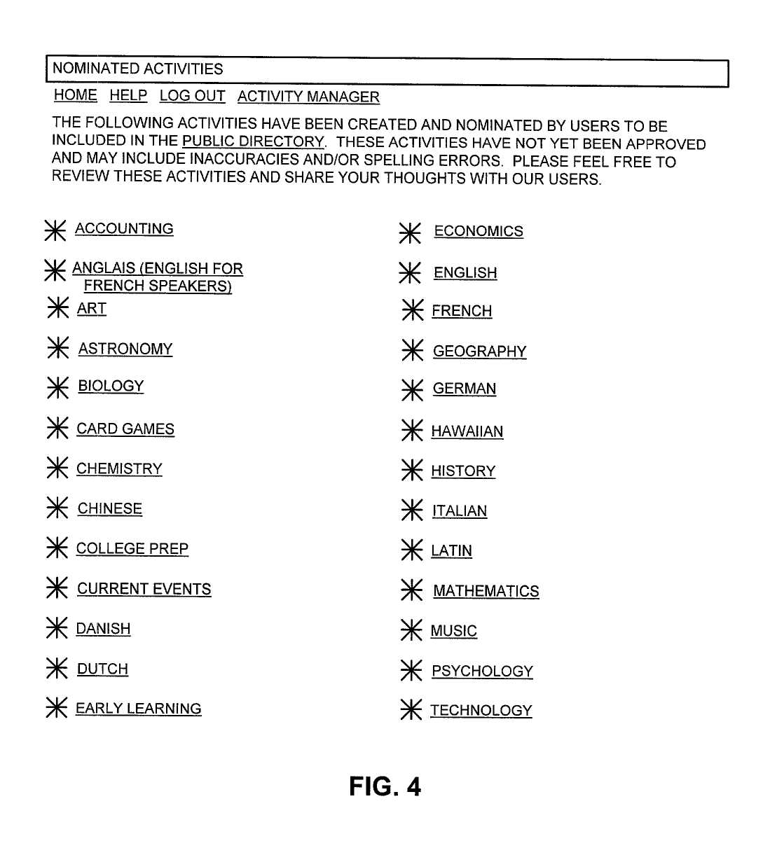

FIG. 4 illustrates nominated activities page 302 in accordance with an embodiment of the present invention. Nominated activities page 302 allows activity evaluators 108-109 to navigate to specific nominated activities categories. Note that nominated activities page 302 also includes a disclaimer.

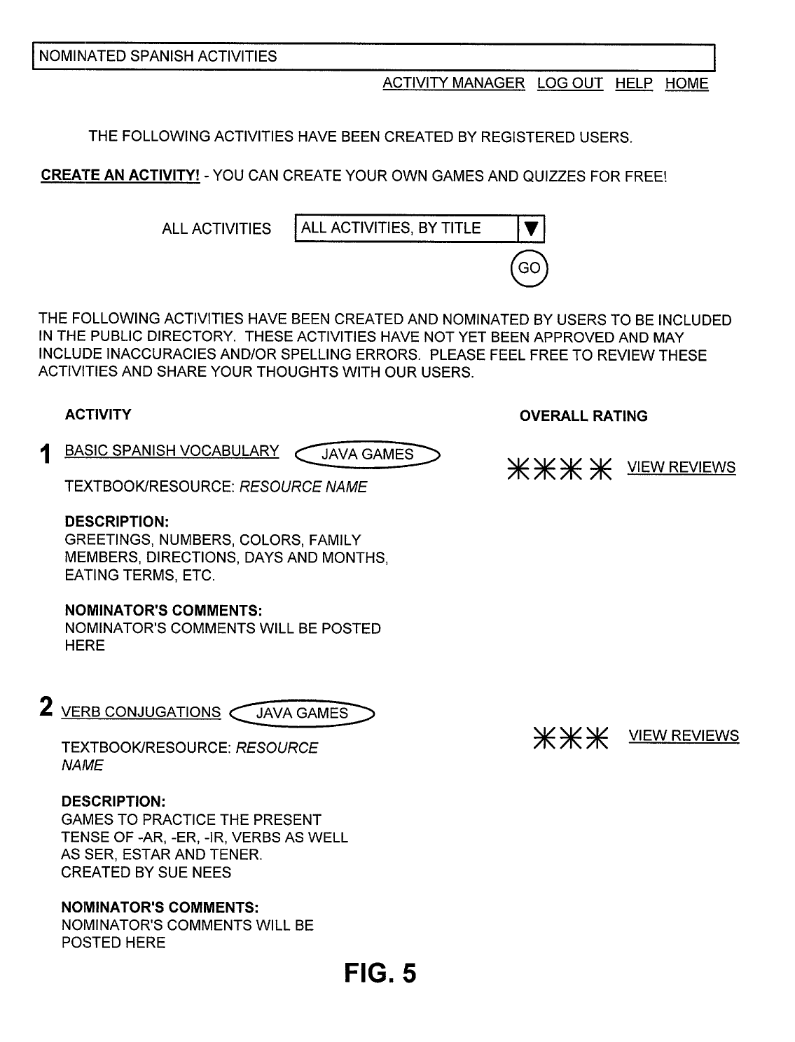

FIG. 5 illustrates nominated activities category page 304 in accordance with an embodiment of the present invention. This page allows activity evaluators 108-109 to review all nominated activities in a particular category. This page also provides a description of each activity in the category, as well as an overall rating for the activity and a link to evaluation results page 308, which enables activity evaluators 108-109 to view results of other activity evaluators.

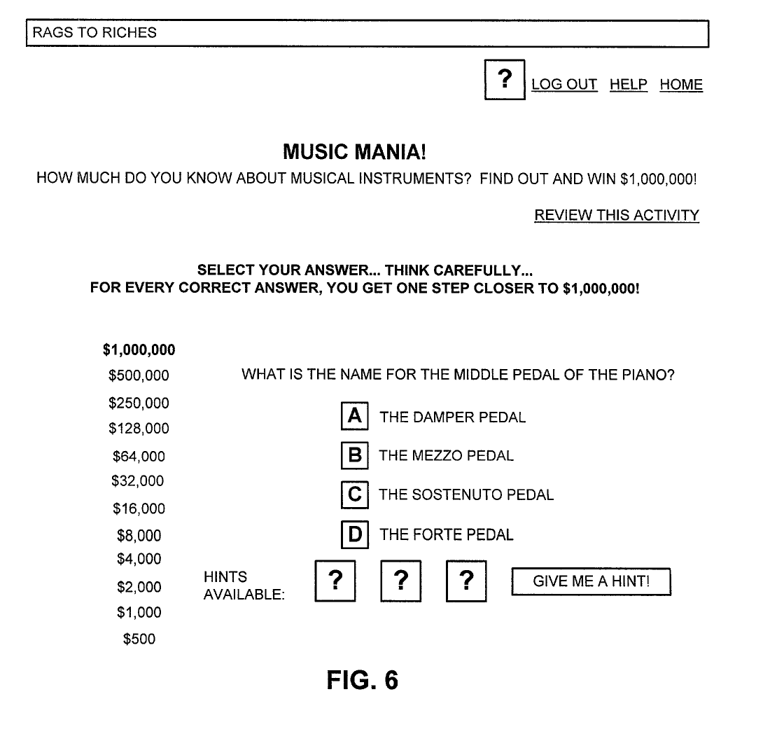

FIG. 6 illustrates activity page 306 for a nominated activity in accordance with an embodiment of the present invention. This activity page enables activity evaluators 108-109 to try out the activity. Note that activity page 306 includes a “review this activity” link that allows activity evaluators 108-109 to access activity review page 310.

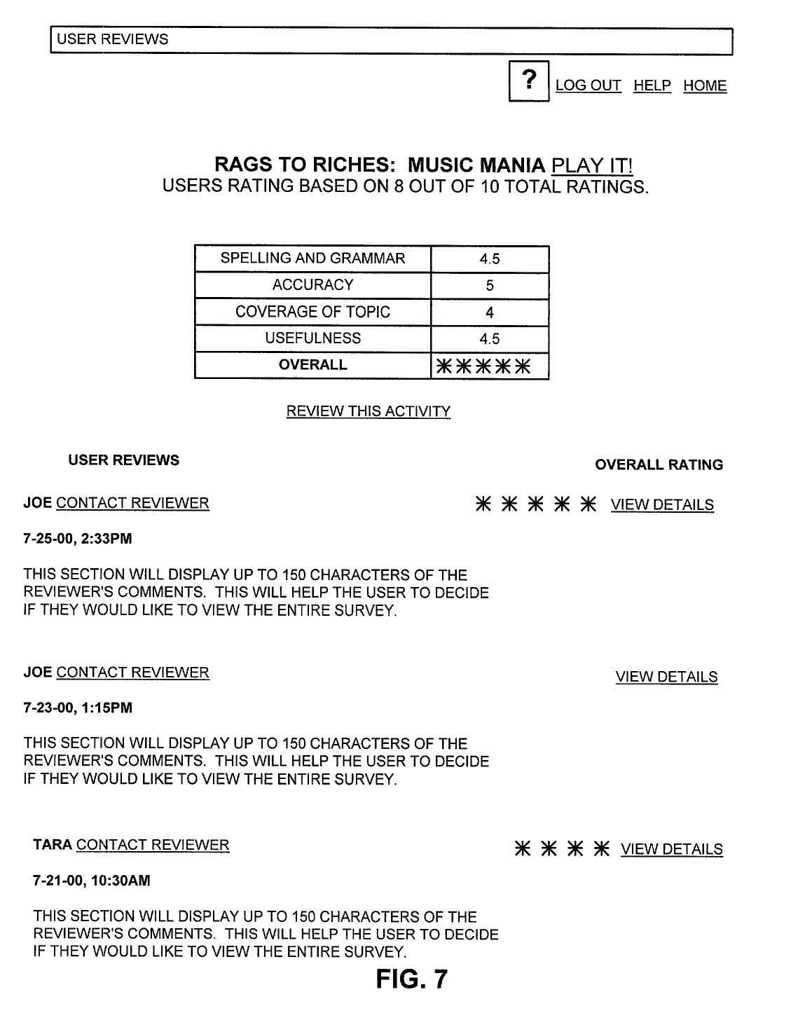

FIG. 7 illustrates evaluation results page 308 for an activity in accordance with an embodiment of the present invention. This page presents summarized evaluation results for he activity as well as reviewer comments. It also provides links to individual evaluations and links to contact specific reviewers. Evaluation results page 308 also includes a “review this activity” link that allows activity evaluators 108-109 to access activity review page 310.

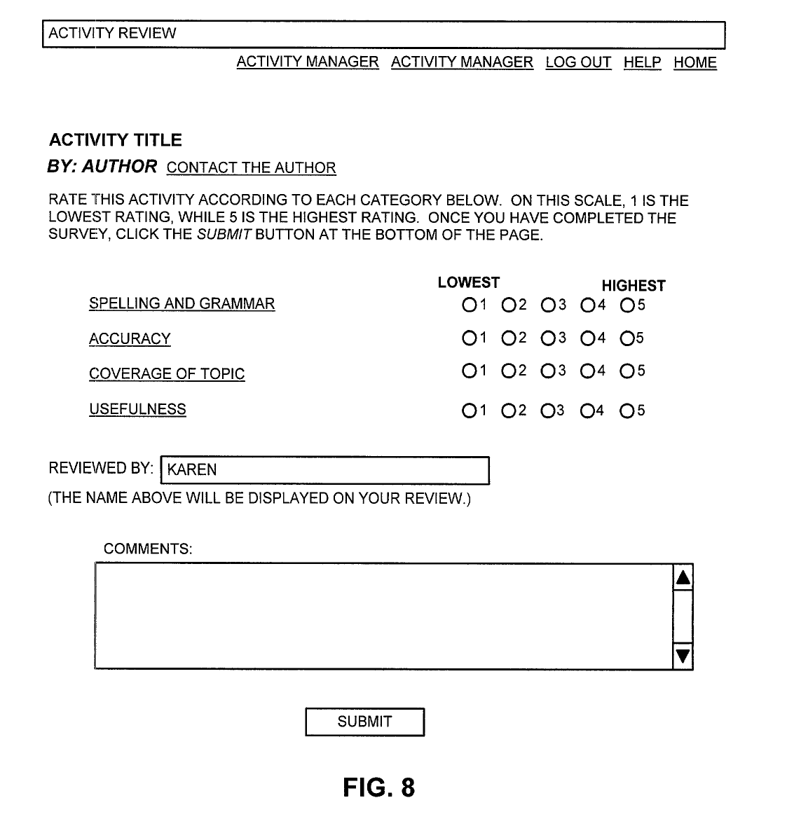

FIG. 8 illustrates an activity review page in accordance with an embodiment of the present invention. Activity review page 310 facilitates providing a numerical score for: spelling and grammar of an activity, accuracy of an activity, topic coverage of an activity, and usefulness of an activity. Activity review page 310 also includes a space for textual comments on the activity.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating a peer review process for a computer-based activity, comprising:
receiving a computer-based activity to be evaluated through the peer review process;
making the computer-based activity available for evaluation by a plurality of evaluators, by making the computer-based activity available on a computer system coupled to a network, so that the computer-based activity can be accessed by remote computer systems across the network;
receiving evaluations from the plurality of evaluators across the network; and
tabulating the evaluations from the plurality of evaluators to produce an evaluation result.

2. The method of claim 1, wherein the computer-based activity includes one of:
a computer-based quiz;
a computer-based examination; and
a computer-based game.

3. The method of claim 1, wherein receiving the computer-based activity involves receiving a nomination for the computer-based activity from a creator of the computer-based activity.

4. The method of claim 1, wherein making the computer-based activity available for evaluation involves making the computer-based activity available on a web site that is accessible by the plurality of evaluators.

5. The method of claim 1, wherein if the evaluation result exceeds a threshold, the computer-based activity is placed in a public directory on the computer system, so that the computer-based activity becomes available to activity users from remote computer systems across the network.

6. The method of claim 5, wherein the method further comprises making the evaluation result available to activity users who can access the computer-based activity.

7. The method of claim 1, wherein the method further comprises automatically screening the computer-based activity for offensive language before making the computer-based activity available for evaluation.

8. The method of claim 1, wherein tabulating the evaluations involves waiting until a minimum number of evaluations are received for the computer-based activity before tabulating the evaluations.

9. The method of claim 1,
wherein the computer-based activity is a computer-based quiz; and
wherein the evaluations include scores for,
spelling and grammar,
accuracy,
topic coverage, and
usefulness of the computer-based quiz.

10. The method of claim 1, wherein making the computer-based activity available for evaluation involves making the computer-based activity accessible under an activity category that is specified by a creator of the computer-based activity.

11. The method of claim 1, wherein the evaluations include textual comments from the plurality of evaluators.

12. A computer-readable storage medium storing instructions that when executed by a computer cause the computer to perform a method for facilitating a peer review process for a computer-based activity, the method comprising:
receiving a computer-based activity to be evaluated through the peer review process;
making the computer-based activity available for evaluation by a plurality of evaluators, by making the computer-based activity available on a computer system coupled to a network, so that the computer-based activity can be accessed by remote computer systems across the network;
receiving evaluations from the plurality of evaluators across the network; and
tabulating the evaluations from the plurality of evaluators to produce an evaluation result.

13. The computer-readable storage medium of claim 12, wherein the computer-based activity includes one of:
a computer-based quiz;
a computer-based examination; and
a computer-based game.

14. The computer-readable storage medium of claim 12, wherein receiving the computer-based activity involves receiving a nomination for the computer-based activity from a creator of the computer-based activity.

15. The computer-readable storage medium of claim 12, wherein making the computer-based activity available for evaluation involves making the computer-based activity available on a web site that is accessible by the plurality of evaluators.

16. The computer-readable storage medium of claim 12, wherein if the evaluation result exceeds a threshold, the computer-based activity is placed in a public directory on the computer system, so that the computer-based activity becomes available to activity users from remote computer systems across the network.

17. The computer-readable storage medium of claim 16, wherein the method further comprises making the evaluation result available to activity users who can access the computer-based activity.

18. The computer-readable storage medium of claim 12, wherein the method further comprises automatically screening the computer-based activity for offensive language before making the computer-based activity available for evaluation.

19. The computer-readable storage medium of claim 12, wherein tabulating the evaluations involves waiting until a minimum number of evaluations are received for the computer-based activity before tabulating the evaluations.

20. The computer-readable storage medium of claim 12,
wherein the computer-based activity is a computer-based quiz; and
wherein the evaluations include scores for,
spelling and grammar,
accuracy,
topic coverage, and
usefulness of the computer-based quiz.

21. The computer-readable storage medium of claim 12, wherein making the computer-based activity available for evaluation involves making the computer-based activity accessible under an activity category that is specified by a creator of the computer-based activity.

22. The computer-readable storage medium of claim 12, wherein the evaluations include textual comments from the plurality of evaluators.

23. An apparatus that facilitates a peer review process for a computer-based activity, comprising:
a receiving mechanism that is configured to receive a computer-based activity to be evaluated through the peer review process;
an access mechanism that is configured to make the computer-based activity available for evaluation by a plurality of evaluators, by making the computer-based activity available on a computer system coupled to a network, so that the computer-based activity can be accessed by remote computer systems across the network;
wherein the receiving mechanism is additionally configured to receive evaluations from the plurality of evaluators across the network; and
a tabulating mechanism that is configured to tabulate the evaluations from the plurality of evaluators to produce an evaluation result.

24. The apparatus of claim 23, wherein the computer-based activity includes one of:
a computer-based quiz;
a computer-based examination; and
a computer-based game.

25. The apparatus of claim 23, wherein the receiving mechanism is configured to receive a nomination for the computer-based activity from a creator of the computer-based activity.

26. The apparatus of claim 23, wherein the access mechanism is configured to make the computer-based activity available on a web site that is accessible by the plurality of evaluators.

27. The apparatus of claim 23, further comprising a publication mechanism that is configured to place the computer-based activity in a public directory on the computer system if the evaluation result exceeds a threshold, so that the computer-based activity becomes available to activity users from remote computer systems across the network.

28. The apparatus of claim 27, wherein the publication mechanism is additionally configured to make the evaluation result available to activity users who can access the computer-based activity.

29. The apparatus of claim 23, further comprising a screening mechanism that is configured to automatically screen the computer-based activity for offensive language before making the computer-based activity available for evaluation.

30. The apparatus of claim 23, wherein the tabulating mechanism is configured to wait until a minimum number of evaluations are received for the computer-based activity before tabulating the evaluations.

31. The apparatus of claim 23,
wherein the computer-based activity is a computer-based quiz; and
wherein the evaluations include scores for,
spelling and grammar,
accuracy,
topic coverage, and
usefulness of the computer-based quiz.

32. The apparatus of claim 23, wherein the access mechanism is configured to make the computer-based activity accessible under an activity category that is specified by a creator of the computer-based activity.

33. The apparatus of claim 23, wherein the evaluations include textual comments from the plurality of evaluators.
